(19) United States
(12) Patent Application Publication
(10) Pub. No.: US 2021/0042390 A1
(43) Pub. Date: Feb. 11, 2021

(54) Common Labeled Annotated Document Transcription for Coordinating Annotation of Documents

(71) Applicant: International Business Machines Corporation, Armonk, NY (US)

(72) Inventors: Tongkai Shao, San Jose, CA (US); Xianying Liu, Fremont, CA (US); Sheng Hua Bao, San Jose, CA (US); Nan Liu, San Jose, CA (US); Pathirage Dinindu Sujan Udayanga Perera, San Jose, CA (US); Feng Wang, Santa Clara, CA (US); Abhinandan Kelgere Ramesh, San Jose, CA (US)

(21) Appl. No.: 16/534,033

(22) Filed: Aug. 7, 2019

(51) Int. Cl. G06F 17/27; G06F 16/93

(52) U.S. Cl. CPC G06F 17/2785; G06F 17/2705; G06F 16/93

(57) ABSTRACT

A mechanism is provided in data processing system comprising at least one processor and at least one memory, the at least one memory comprising instructions that are executed by the at least one processor to specifically configure the at least one processor to implement a common labeled annotated document converter. A transcription service receives a natural language electronic document to be annotated for processing by a cognitive computing system. The cognitive computing system performs natural language processing and cognitive analysis of features extracted from content of the natural language electronic document based on annotations associated with the natural language electronic document. The transcription service processes the natural language electronic document to convert the natural language electronic document from a first format of the natural language electronic document to a common labeled annotated document (CLAD) format. The CLAD format specifies a common set of annotations useable by different elements of the cognitive computing system.

### BACKGROUND

The present application relates generally to an improved data processing apparatus and method and more specifically to mechanisms for common labeled annotated document transcription for coordinating annotation of documents.

Deep learning, also known as deep structured learning or hierarchical learning, is part of a broader family of machine learning methods based on learning data representations, as opposed to task-specific algorithms. Learning can be supervised, semi-supervised or unsupervised. Deep learning architectures, such as deep neural networks, deep belief networks, and recurrent neural networks, have been applied to fields including computer vision, speech recognition, natural language processing, audio recognition, social network filtering, machine translation, bioinformatics, drug design, medical image analysis, material inspection and board game programs, where they have produced results comparable to and in some cases superior to human experts.

Unstructured Information Management Architecture (UIMA) is a standard for content analytics. UIMA provides a component software architecture for the development, discovery, composition, and deployment of multi-modal analytics for the analysis of unstructured information and integration with search technologies. The UIMA architecture can be thought of in four dimensions: it specifies component interfaces in an analytics pipeline; it describes a set of Design patterns; it suggests two data representations: an in-memory representation of annotations for high-performance analytics and an XML representation of annotations for integration with remote web services; and, it suggests development roles allowing tools to be used by users with diverse skills.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in data processing system comprising at least one processor and at least one memory, the at least one memory comprising instructions that are executed by the at least one processor to specifically configure the at least one processor to implement a common labeled annotated document converter. The method comprises receiving, by a transcription service computing device, a natural language electronic document to be annotated for processing by a cognitive computing system. The cognitive computing system performs natural language processing and cognitive analysis of features extracted from content of the natural language electronic document based on annotations associated with the natural language electronic document. The method further comprises processing, by a transcription service computing device, the natural language electronic document to convert the natural language electronic document from a first format of the natural language electronic document to a common labeled annotated document (CLAD) format. The CLAD format specifies a common set of annotations useable by different elements of the cognitive computing system. The method further comprises inputting the converted natural language electronic document to the cognitive computing system. The method further comprises processing, by the cognitive computing system, the converted natural language electronic document by applying multiple different applications of the cognitive computing system to content of the converted natural language electronic document. Each of the multiple different applications utilize annotations specified in the CLAD format to perform processing of the content of the converted natural language electronic document to coordinate their operations with operations of other applications in the cognitive computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented.

FIG. 3 depicts an example of a common labeled annotated document (CLAD) schema in accordance with an illustrative embodiment;

FIG. 4 is a block diagram illustrating a common labeled annotated document (CLAD) transcription service for coordinating annotation of documents in accordance with an illustrative embodiment; and

FIG. 5 is a flowchart illustrating operation of a common labeled annotated document (CLAD) transcription service for coordinating annotation of documents in accordance with an illustrative embodiment.

### DETAILED DESCRIPTION

Unstructured Information Management Architecture (UIMA) is a pipeline that has a bucket structure into which the cognitive system can add data portions or passages. The passages then go down the pipeline.

The illustrative embodiments are directed to solving the issue of a complex cognitive system having a plurality of different components needing to coordinate and communicate with one another. In particular, the illustrative embodiments are concerned with providing a mechanism that provides a transcription service and a common format to allow collaboration between components of a complex, and potentially distributed cognitive system.

The illustrative embodiments provide a transcription service that transcribes input documents into a common input/output format, referred to as Common Labeled Annotated Document (CLAD), which is usable by a complex cognitive system, such as, for example, IBM Watson™ for Patient Safety.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

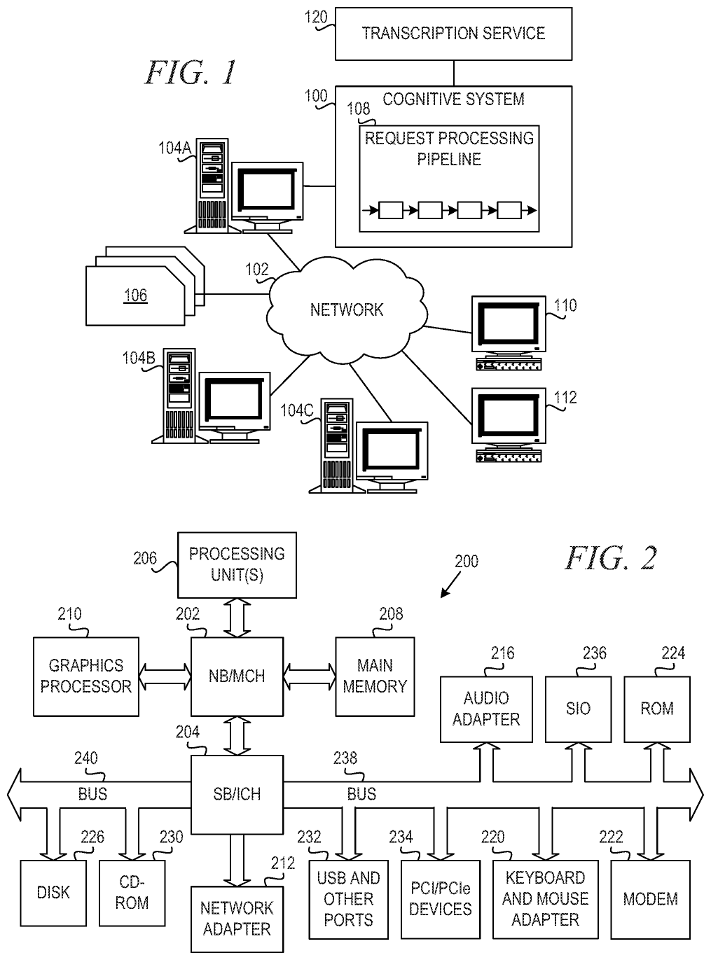

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a schematic diagram of one illustrative embodiment of a cognitive system 100 implementing a request processing pipeline 108 in a computer network 102. The cognitive system 100 is implemented on one or more computing devices 104A-C (comprising one or more processors and one or more memories, and potentially any other computing device elements generally known in the art including buses, storage devices, communication interfaces, and the like) connected to the computer network 102. For purposes of illustration only, FIG. 1 depicts the cognitive system 100 being implemented on computing device 104A only, but as noted above the cognitive system 100 may be distributed across multiple computing devices, such as a plurality of computing devices 104A-C. The network 102 includes multiple computing devices 104A-C, which may operate as server computing devices, and 110-112 which may operate as client computing devices, in communication with each other and with other devices or components via one or more wired and/or wireless data communication links, where each communication link comprises one or more of wires, routers, switches, transmitters, receivers, or the like. In some illustrative embodiments, the cognitive system 100 and network 102 may provide cognitive operations including, but not limited to, request processing and cognitive response generation which may take many different forms depending upon the desired implementation, e.g., cognitive information retrieval, training/instruction of users, cognitive evaluation of data, or the like. Other embodiments of the cognitive system 100 may be used with components, systems, sub-systems, and/or devices other than those that are depicted herein.

The cognitive system 100 is configured to implement a request processing pipeline 108 that receive inputs from various sources. The requests may be posed in the form of a natural language request, natural language request for information, natural language request for the performance of a cognitive operation, or the like. For example, the cognitive system 100 receives input from the network 102, a corpus or corpora of electronic documents 106, cognitive system users, and/or other data and other possible sources of input. In one embodiment, some or all of the inputs to the cognitive system 100 are routed through the network 102. The various computing devices 104A-C on the network 102 include access points for content creators and cognitive system users. Some of the computing devices 104A-C include devices for a database storing the corpus or corpora of data 106 (which is shown as a separate entity in FIG. 1 for illustrative purposes only). Portions of the corpus or corpora of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus or corpora of data 106 for use as part of a corpus of data with the cognitive system 100. The document includes any file, text, article, or source of data for use in the cognitive system 100. Cognitive system users access the cognitive system 100 via a network connection or an Internet connection to the network 102, and input requests to the cognitive system 100 that are processed based on the content in the corpus or corpora of data 106. In one embodiment, the requests are formed using natural language. The cognitive system 100 parses and interprets the request via a pipeline 108, and provides a response to the cognitive system user, e.g., cognitive system user 110, containing one or more response to the request, results of processing the request, or the like. In some embodiments, the cognitive system 100 provides a response to users in a ranked list of candidate responses while in other illustrative embodiments, the cognitive system 100 provides a single final response or a combination of a final response and ranked listing of other candidate responses.

The cognitive system 100 implements the pipeline 108 which comprises a plurality of stages for processing an input request based on information obtained from the corpus or corpora of data 106. The pipeline 108 generates responses for the input request based on the processing of the input request and the corpus or corpora of data 106.

As noted above, while the input to the cognitive system 100 from a client device may be posed in the form of a natural language request, the illustrative embodiments are not limited to such. Rather, the input request may in fact be formatted or structured as any suitable type of request which may be parsed and analyzed using structured and/or unstructured input analysis, including but not limited to the natural language parsing and analysis mechanisms of a cognitive system such as IBM Watson™ for Patent Safety, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, cognitive system 100 may provide a cognitive functionality for assisting with healthcare based operations. For example, depending upon the particular implementation, the healthcare based operations may comprise patient diagnostics medical practice management systems, personal patient care plan generation and monitoring, or patient electronic medical record (EMR) evaluation for various purposes. Thus, the cognitive system 100 may be a healthcare cognitive system 100 that operates in the medical or healthcare type domains and which may process requests for such healthcare operations via the request processing pipeline 108 input as either structured or unstructured requests, natural language input, or the like.

As shown in FIG. 1, the cognitive system 100 is further augmented, in accordance with the mechanisms of the illustrative embodiments, to include logic implemented in specialized hardware, software executed on hardware, or any combination of specialized hardware and software executed on hardware, for implementing a transcription service 120 that transcribes input documents into a common input/output format, referred to as Common Labeled Annotated Document (CLAD), which is useable by a complex cognitive system. This transcription to a common format allows for easier implementation of Application Programming Interfaces (APIs) because the ordering of what services to call is no longer required to be known a priori. Services may be called in any order or even in parallel.

As noted above, the mechanisms of the illustrative embodiments utilize specifically configured computing devices, or data processing systems, to perform the operations for common labeled annotated document transcription for coordinating annotation of documents. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the common labeled annotated document transcription.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

The illustrative embodiments provide a common document schema for all document types, referred to as the Common Labeled Annotated Document (CLAD) schema, which allows integration of different components into the cognitive system. The CLAD schema specifies the document attributes, label attributes, and annotation attributes. In the document attributes, the CLAD schema specifies all the information for the input of the document (docId, doctype, content, filename, sentences, attributes). In the label attributes, the CLAD schema specifies all the information for input of document labels, e.g., the label type, label confidence, etc. In the annotation attributes, the CLAD schema specifies entity annotations and relationship annotations. For a source document, such as a medical report provided as a Portable Document Format (PDF) file, a transcription service of the illustrative embodiment converts the PDF file to the CLAD format (JavaScript Object Notation (JSON) style format) such that it may be utilized by the various components of the cognitive system.

The transcription service gathers document information (highlighting, comments, and optical character recognition (OCR) information) and then converts this information to the common format (CLAD), from which the cognitive system obtains any needed annotations.

The illustrative embodiments provide for the implementation of a coordinated cognitive system pipeline that operates on various annotations that different sources have registered in the pipeline. For example, a coordinated pipeline may include components that study for adverse effects in one application, drug interactions in another application, and the coordinated pipeline looks at all of them to get annotations from across the applications. The coordination is facilitated by the common document format (CLAD), e.g., there may be different annotations operated on by different applications in different machines, and these operations may be reconciled into a common document format that comprises all of the annotations.

The transcription service of the illustrative embodiments can do classification at the annotation level and not at the document level. One annotation may influence another annotator—adverse effect can influence drug interaction annotator.

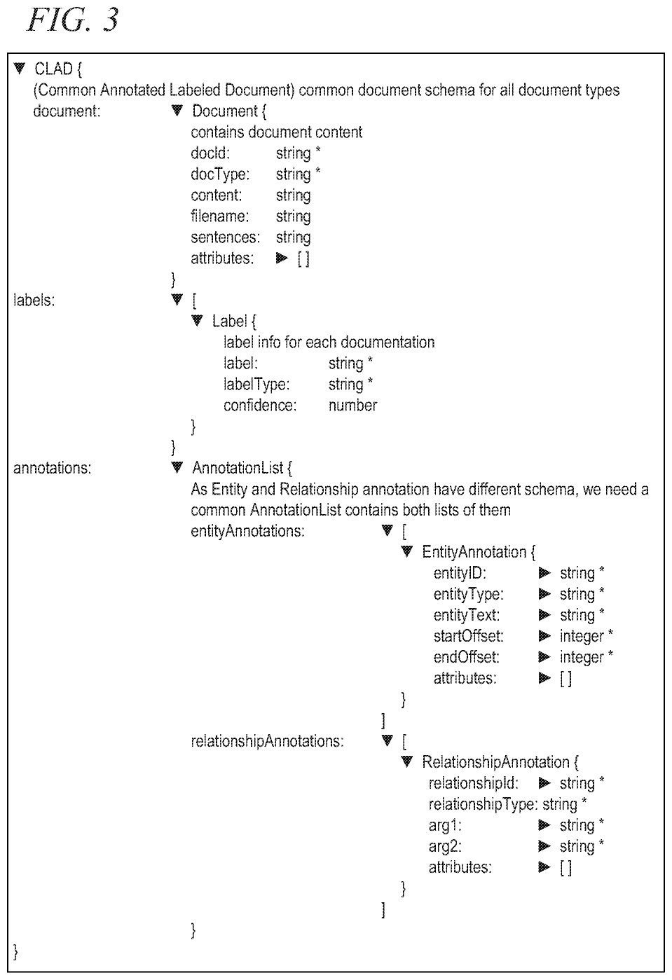

FIG. 3 depicts an example of a common labeled annotated document (CLAD) schema in accordance with an illustrative embodiment.

Following is an example of a CLAD formatted document, using JSON file format, in accordance with one illustrative embodiment:

Examiner document in CLAD format

{

“CLAD”: {

“document”: {

“docId”: 1,
“docType”: “spontaneous report”,
“content”: “Cholestatic hepatitis after administration of

furan derivatives. A patient
developed cholestatic hepatitis while being treated with nitrofurantoin. A
second episode of
jaundice followed the intravaginal administration of a mixture of
furazolidone and nifuroxime. It
is important to consider possible cross-sensitivity of chemically related
compounds even when
they are administered by different routes.”,

“attributes”: [

```
{
  “name”: “age”,
  “value”: “52”
},
{
```

“name”: “gender”,
“value”: “Male”

}

]

},
“labels”: [

{

“label”: “YES”,
“labelType”: “ICSR_CLASSIFICATION”,
“confidence”: 0.7

},

{

“label”: “NO”,
“labelType”: “REPORTER_CAUSALITY”

}

],
“annotations”: {

“entityAnnotations”: [

{

“entityId”: 1,
“entityType”: “ADVERSE_EVENT”,
“entityText”: “cholestatic hepatitis”,
“startOffset”: 86,
“endOffset”: 107,
“attributes”: [

{

“name”: “confidence”,
“value”: 0.7

},
{

“name”: “MedDRA_code”,
“value”: 10008235

}

]

},
{

“entityId”: 2,
“entityType”: “DRUG”,
“entityText”: “nitrofurantoin”,
“startOffset”: 133,
“endOffset”: 147,
“attributes”: [

{

“name”: “confidence”,
“value”: 0.9

},
{

“name”: “WHO_DD_code”,
“value”: 666

}

]

}

],
“relationshipAnnotations”: [

{

“relationshipId”: 1,
“relationshipType”: “Related”,
“arg1”: “ARG1”,
“arg1Id”:“1”,
“arg2Id”:“2”,
“arg2”: “ARG2”,
“attributes”: [

{

“name”: “confidence”,
“value”: 0.7

}

]

}

]

}

}

}

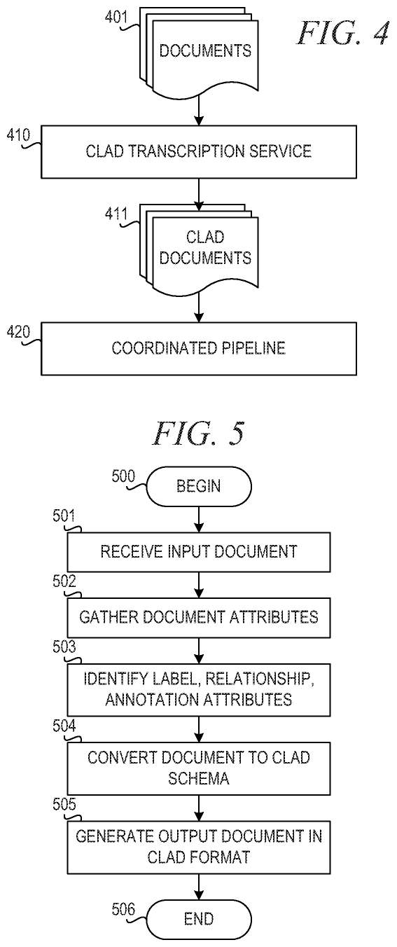

FIG. 4 is a block diagram illustrating a common labeled annotated document (CLAD) transcription service for coordinating annotation of documents in accordance with an illustrative embodiment. The CLAD transcription service 410 receives electronic documents 401 to be annotated for processing by a cognitive computing system. The cognitive computing system performs natural language processing and cognitive analysis of features extracted from content of the natural language electronic documents 401 based on annotations associated with the natural language electronic document. The transcription service 410 processes the natural language electronic documents 401 to convert the natural language electronic documents 401 from a first format of the natural language electronic document to a common labeled annotated document (CLAD) format, which specifies a common set of annotations useable by different elements of the cognitive computing system.

The CLAD transcription service 410 outputs the converted natural language electronic documents in CLAD format 411 to a coordinated pipeline 420 of the cognitive computing system. The coordinated pipeline 420 processes the converted natural language electronic documents 411 by applying multiple different applications of the cognitive computing system to content of the converted natural language electronic document 411. Each of the multiple different applications utilize annotations specified in the CLAD format to perform processing of the content of the converted natural language electronic document to coordinate their operations with operations of other applications in the cognitive computing system

FIG. 5 is a flowchart illustrating operation of a common labeled annotated document (CLAD) transcription service for coordinating annotation of documents in accordance with an illustrative embodiment. Operation begins (block 500), and the transcription service receives an input document (block 501). The transcription service gathers document attributes (block 502) and identifies label, relationship, and annotation attributes (block 503). The transcription service then converts the document to the CLAD schema (block 504) and generates the output document in the CLAD format (block 505). Thereafter, operation ends (block 506).

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in data processing system comprising at least one processor and at least one memory, the at least one memory comprising instructions that are executed by the at least one processor to specifically configure the at least one processor to implement a common labeled annotated document converter, wherein the method comprises:
receiving, by a transcription service computing device, a natural language electronic document to be annotated for processing by a cognitive computing system, wherein the cognitive computing system performs natural language processing and cognitive analysis of features extracted from content of the natural language electronic document based on annotations associated with the natural language electronic document;
processing, by a transcription service computing device, the natural language electronic document to convert the natural language electronic document from a first format of the natural language electronic document to a common labeled annotated document (CLAD) format, wherein the CLAD format specifies a common set of annotations useable by different elements of the cognitive computing system;
inputting the converted natural language electronic document to the cognitive computing system; and
processing, by the cognitive computing system, the converted natural language electronic document by applying multiple different applications of the cognitive computing system to content of the converted natural language electronic document, wherein each of the multiple different applications utilize annotations specified in the CLAD format to perform processing of the content of the converted natural language electronic document to coordinate their operations with operations of other applications in the cognitive computing system.

2. The method of claim 1, wherein the CLAD format comprises predefined document attributes, label attributes, and annotation attributes, which are common to the multiple different applications of the cognitive computing system.

3. The method of claim 2, wherein the predefined document attributes comprise information for input of the electronic document into the cognitive computing system, and wherein the document attributes comprise a document identifier, a document type, a content, and a filename.

4. The method of claim 2, wherein the predefined label attributes comprise information for input of labels associated with the electronic document into the cognitive computing system, and wherein the label attributes comprise a label type and a label confidence.

5. The method of claim 2, wherein the annotation attributes comprise entity annotations and relationship annotations.

6. The method of claim 5, wherein the relationship annotations comprise a relationship identifier, a relationship type, one or more relationship arguments, and one or more relationship attributes.

7. The method of claim 1, wherein the multiple different applications of the cognitive computing system comprise a coordinated pipeline, wherein different annotations are operated on by different applications in different machines, and wherein the operations are reconciled into a common document format that comprises all of the annotations.

8. A computer program product comprising a computer readable storage medium having a computer readable program stored therein, wherein the computer readable program comprises instructions, which when executed on a processor of a computing device causes the computing device to implement a common labeled annotated document converter, wherein the computer readable program causes the computing device to:
receive, by a transcription service computing device, a natural language electronic document to be annotated for processing by a cognitive computing system, wherein the cognitive computing system performs natural language processing and cognitive analysis of features extracted from content of the natural language electronic document based on annotations associated with the natural language electronic document;
process, by a transcription service computing device, the natural language electronic document to convert the natural language electronic document from a first format of the natural language electronic document to a common labeled annotated document (CLAD) format, wherein the CLAD format specifies a common set of annotations useable by different elements of the cognitive computing system;
input the converted natural language electronic document to the cognitive computing system; and
process, by the cognitive computing system, the converted natural language electronic document by applying multiple different applications of the cognitive computing system to content of the converted natural language electronic document, wherein each of the multiple different applications utilize annotations specified in the CLAD format to perform processing of the content of the converted natural language electronic document to coordinate their operations with operations of other applications in the cognitive computing system.

9. The computer program product of claim 8, wherein the CLAD format comprises predefined document attributes, label attributes, and annotation attributes, which are common to the multiple different applications of the cognitive computing system.

10. The computer program product of claim 9, wherein the predefined document attributes comprise information for input of the electronic document into the cognitive computing system, and wherein the document attributes comprise a document identifier, a document type, a content, and a filename.

11. The computer program product of claim 9, wherein the predefined label attributes comprise information for input of labels associated with the electronic document into the cognitive computing system, and wherein the label attributes comprise a label type and a label confidence.

12. The computer program product of claim 9, wherein the annotation attributes comprise entity annotations and relationship annotations.

13. The computer program product of claim 12, wherein the relationship annotations comprise a relationship identifier, a relationship type, one or more relationship arguments, and one or more relationship attributes.

14. The computer program product of claim 8, wherein the multiple different applications of the cognitive computing system comprise a coordinated pipeline, wherein different annotations are operated on by different applications in different machines, and wherein the operations are reconciled into a common document format that comprises all of the annotations.

15. A computing device comprising:
a processor; and
a memory coupled to the processor, wherein the memory comprises instructions, which when executed on a processor of a computing device causes the computing device to implement a common labeled annotated document converter, wherein the instructions cause the processor to:
receive, by a transcription service computing device, a natural language electronic document to be annotated for processing by a cognitive computing system, wherein the cognitive computing system performs natural language processing and cognitive analysis of features extracted from content of the natural language electronic document based on annotations associated with the natural language electronic document;
process, by a transcription service computing device, the natural language electronic document to convert the natural language electronic document from a first format of the natural language electronic document to a common labeled annotated document (CLAD) format, wherein the CLAD format specifies a common set of annotations useable by different elements of the cognitive computing system;
input the converted natural language electronic document to the cognitive computing system; and
process, by the cognitive computing system, the converted natural language electronic document by applying multiple different applications of the cognitive computing system to content of the converted natural language electronic document, wherein each of the multiple different applications utilize annotations specified in the CLAD format to perform processing of the content of the converted natural language electronic document to coordinate their operations with operations of other applications in the cognitive computing system.

16. The computing device of claim 15, wherein the CLAD format comprises predefined document attributes, label attributes, and annotation attributes, which are common to the multiple different applications of the cognitive computing system.

17. The computing device of claim 16, wherein the predefined document attributes comprise information for input of the electronic document into the cognitive computing system, and wherein the document attributes comprise a document identifier, a document type, a content, and a filename.

18. The computing device of claim 16, wherein the predefined label attributes comprise information for input of labels associated with the electronic document into the cognitive computing system, and wherein the label attributes comprise a label type and a label confidence.

19. The computing device of claim 16, wherein the annotation attributes comprise entity annotations and relationship annotations.

20. The computing device of claim 19, wherein the relationship annotations comprise a relationship identifier, a relationship type, one or more relationship arguments, and one or more relationship attributes.
